(19) United States
(12) Patent Application Publication
(10) Pub. No.: US 2006/0180262 A1
(43) Pub. Date: Aug. 17, 2006

(54) Manufacturing method of optical elements

(75) Inventors: Naoki Fuse, Osaka (JP); Kiyoshi Hiraoka, Osaka (JP); Kazuyuki Nishi, Osaka (JP); Yoshiyuki Ogawa, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/349,288

(22) Filed: Feb. 7, 2006

(30) Foreign Application Priority Data
Feb. 8, 2005 (JP) 2005-32331
Feb. 8, 2005 (JP) 2005-32332

(51) Int. Cl. B32B 17/10

(52) U.S. Cl. 156/99

(57) ABSTRACT

A method for manufacturing optical elements, having the following steps: preparing a plural number of glass planar plates, each of the planar plates having a light-separating coating on one surface; laminating the planar plates and boding the planar plates together by a translucent first adhesive so as to make a laminate; cutting the laminate in a first direction inclining at a specified angle at a specified pitch so as to make a plural number of laminate divisions; polishing both cut surfaces of each of the laminate divisions; stacking the laminate divisions such that the polished surfaces face each other and temporarily bonding the stacked laminate divisions together by a second adhesive; cutting the temporarily bonded stack of laminate divisions in a second direction perpendicular to surfaces of the stack so as to make a plural number of temporarily bonded plates; polishing both surfaces of each of the temporarily bonded plates; removing the second adhesive so as to make a plural number of long chains of optical elements; forming an anti-reflection coating on each of the chains of optical elements; and cutting each of the chains of optical elements into pieces of a specified size so as to make individual optical elements.

This application is based on Japanese patent application Nos. 2005-32331 and 2005-32332, both of which were filed on Feb. 8, 2005, of which contents are incorporated herewith by reference.

### BACKGROUND OF THE INVENTION

1. Filed of the Invention

The present invention relates to a manufacturing method of optical elements, and more particularly to a manufacturing method of wave-separating/polarized-light-separating prisms and a manufacturing method of prismatic optical elements, each having an inclined reflective surface.

2. Description of Related Art

As a type of optical elements, a polarized beam splitter 1, which is in the shape of a cube, as shown by FIG. 7a is conventionally known. The beam splitter 1 comprises two prisms 2 and 3, which are in the shape of a right triangle pole, integrated together with a polarized-light-separating film 4 in-between. The film 4 may be a wave-separating film.

The beam splitter 1 of this type splits incident light, and more specifically, the beam splitter 1 transmits a component with specified polarization and reflects the other components. Accordingly, as FIG. 7b shows, of a light beam emitted from a light source 5, only a component with specified polarization passes through the polarized-light-separating film 4 and irradiates a disk 6. Since light reflected by the disk 6 has a plane of polarization rotated from that of the light irradiating the disk 6, the light reflected by the disk 6 is reflected by the polarized-light-separating film 4 and is detected by a photosensitive element 7.

Japanese Patent Laid-Open Publication No. 2000-143264 discloses a method for manufacturing beam splitters of this type, comprising the following steps:

(a) a step of preparing a plural number of planar optical elements, each of which has a polarized-light-separating coating formed on one surface and a matching coating on the other surface;

(b) a step of forming a laminate by bonding the optical elements together by an adhesive such that sides of the laminate will be stairs at an angle of 45 degrees;

(c) a step of forming a plural number of laminate divisions by cutting the laminate in a direction tilting at 45 degrees at a specified pitch;

(d) a step of making a mirror treatment to both cut surfaces of each laminate division and forming an anti-reflection coating on the surfaces which were subjected to the mirror treatment;

(e) a step of forming a temporarily bonded stack of laminate divisions by stacking the laminate divisions with anti-reflection coatings at a right angle and by bonding the stacked laminate divisions together by paraffine;

(f) a step of cutting the temporarily bonded stack of laminate divisions in a direction perpendicular to the cut surfaces made by step (c) to form temporarily bonded stack pieces;

(g) a step of making a mirror treatment to both cut surfaces made by step (f) and forming an anti-reflection coating on the surfaces which were subjected to the mirror treatment;

(h) a step of forming a chain of beam splitters by cutting each of the temporarily bonded stack pieces in a direction perpendicular to the cut surfaces made by step (f) at a specified pitch; and

(i) a step of dividing the chain of beam splitters into individual beam splitters by heating the chain of beam splitters to melt and remove the paraffine.

In the manufacturing process above, there are two steps (d) and (h) where an anti-reflection coating is formed by vapor deposition, and the vapor deposition is performed four times in total (on two sides at step (d) and on two sides at step (h)). Further, at the step (h), a gas is generated from the paraffine by the heat applied for vapor deposition, and thereby, the anti-reflection coating will have YAKE (tarnishing) and/or hazing.

FIG. 8 shows a conventional method for manufacturing prismatic mirrors. First, a long chain of mirrors 8 with an inclined surface 8a is made of glass. Next, a reflective coating is formed on the inclined surface 8a of the chain of mirrors 8, and the chain of mirrors 8 is cut at the alternate long and short dash lines into individual mirrors. In this manufacturing process, it is necessary to make many chains of mirrors 8 one by one. Thus, this manufacturing process is not efficient, and a method permitting manufacture of more mirrors at one time is demanded.

### SUMMARY OF THE INVENTION

An object of the present invention is to provide a manufacturing method of optical elements, wherein the number of anti-reflection coating forming steps is reduced to a half of that of a conventional manufacturing method and wherein the reflective coating is prohibited from having YAKE (tarnishing) and/or hazing.

Another object of the present invention is to provide a manufacturing method which permits efficient manufacture of prismatic optical elements with inclined surfaces.

A first aspect of the present invention provides a method for manufacturing optical elements, and the method comprises the steps of

(1-A) preparing a plural number of planar plates made of a transparent material, each of the planar plates having a light-separating coating on one surface;

(1-B) laminating the planar plates and boding the planar plates together by a translucent first adhesive so as to make a laminate;

(1-C) cutting the laminate in a first direction tilting at a specified angle at a specified pitch so as to make a plural number of laminate divisions;

(1-D) polishing both cut surfaces of each of the laminate divisions;

(1-E) stacking the laminate divisions such that the polished surfaces face each other and temporarily bonding the stacked laminate divisions together by a second adhesive;

(1-F) cutting the temporarily bonded stack of laminate divisions in a second direction perpendicular to surfaces of the stack so as to make a plural number of temporarily bonded plates;

(1-G) polishing both cut surfaces of each of the temporarily bonded plates;

(1-H) removing the second adhesive so as to make a plural number of long chains of optical elements;

(1-I) forming an anti-reflection coating on each of the chains of optical elements; and

(1-J) cutting each of the chains of optical elements into pieces of a specified size so as to make individual optical elements.

In the method according to the first aspect of the present invention, at the anti-reflection coating forming step (1-I), an anti-reflection coating is formed by vapor deposition, and two adjacent surfaces of each chain of optical elements are concurrently subjected to the formation of an anti-reflection coating. Accordingly, vapor deposition is performed only twice toward a long chain of optical elements. Thus, the number of vapor deposition processes is a half of that in the conventional method. Also, since this step (1-I) is executed after removing the second adhesive, there is no fear that a gas may generate from the adhesive by a heat applied for vapor deposition, and even if paraffine is used as the second adhesive, there is no fear that the anti-reflection coating will have YAKE (tarnishing) and/or hazing.

In the method according to the first aspect of the present invention, preferably, a photosetting adhesive with a refractive index nearly equal to that of the planar plates is used as the first adhesive. Also, at the stacking and temporarily bonding step (1-E), preferably, a light cure adhesive is used as the second adhesive, and the light cure adhesive is temporarily hardened.

A second aspect of the present invention provides a method for manufacturing optical elements, and the method comprises the steps of:

(2-A) preparing a plural number of planar plates made of a transparent material;

(2-B) laminating the planar plates and temporarily boding the planar plates together by a first adhesive so as to make a laminate;

(2-C) cutting the laminate in a first direction tilting at a specified angle at a specified pitch so as to make a plural number of laminate divisions;

(2-D) stacking the laminate divisions such that cut surfaces face each other and temporarily bonding the stacked laminate divisions together by a second adhesive;

(2-E) cutting the temporarily bonded stack of laminate divisions in a second direction perpendicular to surfaces of the stack so as to make a plural number of temporarily bonded plates;

(2-F) removing the first and second adhesives so as to make a plural number of long chains of optical elements; and

(2-G) cutting each of the chains of optical elements into pieces of a specified size so as to make individual optical elements.

In the method according to the second aspect of the present invention, long chains of optical elements are obtained after the steps of: making a laminate of transparent planar plates by temporarily bonding the planar plates together by a first adhesive, cutting the laminate into a plural number of laminate divisions, stacking and temporarily bonding the laminate divisions together by a second adhesive, cutting the stack of laminate divisions into a plural number of temporarily bonded planar plates and removing the first and second adhesives. Thus, by following these steps, long chains of optical elements can be obtained efficiently. Since the stage right before obtaining optical elements (mirrors) is efficient, prismatic optical elements, each having an inclined reflective surface, can be obtained efficiently.

In the method according to the second aspect of the present invention, at the step of cutting the temporarily bonded stack of laminate divisions in a second direction (2-E), preferably, the cutting positions are in the middles of the temporarily bonded surfaces of the planar plates. Thereby, identical optical elements can be manufactured efficiently.

A third aspect of the present invention provides a method for manufacturing optical elements, and the method comprises the steps of:

(3-A) preparing a plural number of first transparent planar plates with a first thickness and a plural number of second planar plates with a second thickness smaller than the first thickness;

(3-B) laminating the first planar plates and the second planar plates and temporarily boding the first and second planar plates together by a first adhesive so as to make a laminate;

(3-C) cutting the laminate in a first direction tilting at a specified angle at a specified pitch so as to make a plural number of laminate divisions;

(3-D) stacking the laminate divisions such that cut surfaces face each other and temporarily bonding the stacked laminate divisions together by a second adhesive;

(3-E) cutting the temporarily bonded stack of laminate divisions in a second direction perpendicular to surfaces of the stack so as to make a plural number of temporarily bonded plates;

(3-F) removing the first and second adhesives so as to make a plural number of long chains of optical elements; and

(3-G) cutting each of the chains of optical elements into pieces of a specified size so as to make individual optical elements,

(3-H) wherein in the step of cutting the temporarily bonded stack of laminate divisions in the second direction, the cutting positions are so designed to make cut surfaces including the temporarily bonded surfaces of the planar plates and cut surfaces not including the temporarily bonded surfaces of the planar plates.

In the method according to the third aspect of the present invention, as in the method according to the second aspect of the present invention, long chains of optical elements, which will be cut into optical elements immediately, can be obtained efficiently. Further, prismatic optical elements, each having a cut-off corner at an end of an inclined reflective surface, can be manufactured with less waste of material.

In the method according to the second aspect of the present invention, each of the planar plates may have a reflective coating on one surface or on both surfaces. In the method according to the third aspect of the present invention, each of the first planar plates may have a reflective coating on one surface or on both surfaces. Alternatively, the methods according to the second and third aspects of the present invention may further comprise a step of forming a reflective coating on an inclined surface of each of the long chains of optical elements or on an inclined surface of each of the optical elements cut out from the long chains of optical elements.

In the methods according to the second and third aspects of the present invention, a photosetting adhesive may be used as the first and second adhesives, and in this case, the photosensitive adhesive is temporarily hardened.

Further, the methods according to the second and third aspects of the present invention may comprise, after the step of cutting the laminate into laminate divisions, a step of polishing both cut surfaces of the laminate divisions, and after the step of cutting the stack of laminate divisions into temporarily bonded planar plates, a step of polishing both cut surfaces of the temporarily bonded planar plates. Thereby, mirrors which transmit light and reflect light on an internal surface can be obtained.

### BRIEF DESCRIPTION OF THE DRAWINGS

These and other objects and features of the present invention will be apparent from the following description with reference to the accompanying drawings, in which:

FIG. 1 is an illustration showing the former half steps of an inventive method for manufacturing optical elements according to a first embodiment;

FIG. 2 is an illustration showing the latter half steps of the inventive method according to the first embodiment;

FIG. 3 is an illustration showing the steps of an inventive method for manufacturing optical elements according to a second embodiment;

FIG. 4 is an illustration showing the essential steps of an inventive method for manufacturing optical elements according to a third embodiment;

FIG. 5 is an illustration showing the essential steps of an inventive method for manufacturing optical elements according to a fourth embodiment;

FIGS. 6a and 6b are perspective views of optical elements, FIG. 6a showing an optical element manufactured by the method according to the second embodiment and FIG. 6b showing an optical element manufactured by the method according to the fourth embodiment;

FIGS. 7a and 7b show an exemplary beam splitter, FIG. 7a being a perspective view and FIG. 7b being a schematic view showing a usage of the beam splitter; and

FIG. 8 is a perspective view showing a conventional method for manufacturing mirrors.

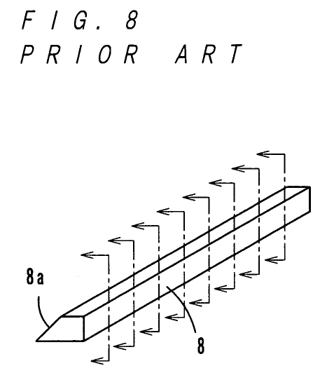

### DETAILED DESCRIPTION OF THE PREFERRED EMBODIMENTS

Embodiments of a manufacturing method of optical elements are hereinafter described with reference to the accompanying drawings.

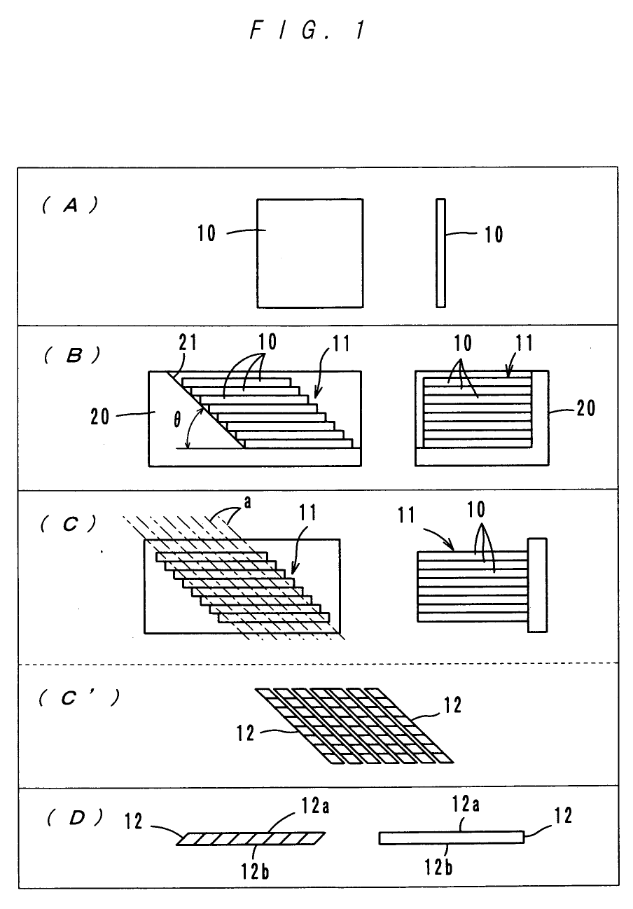

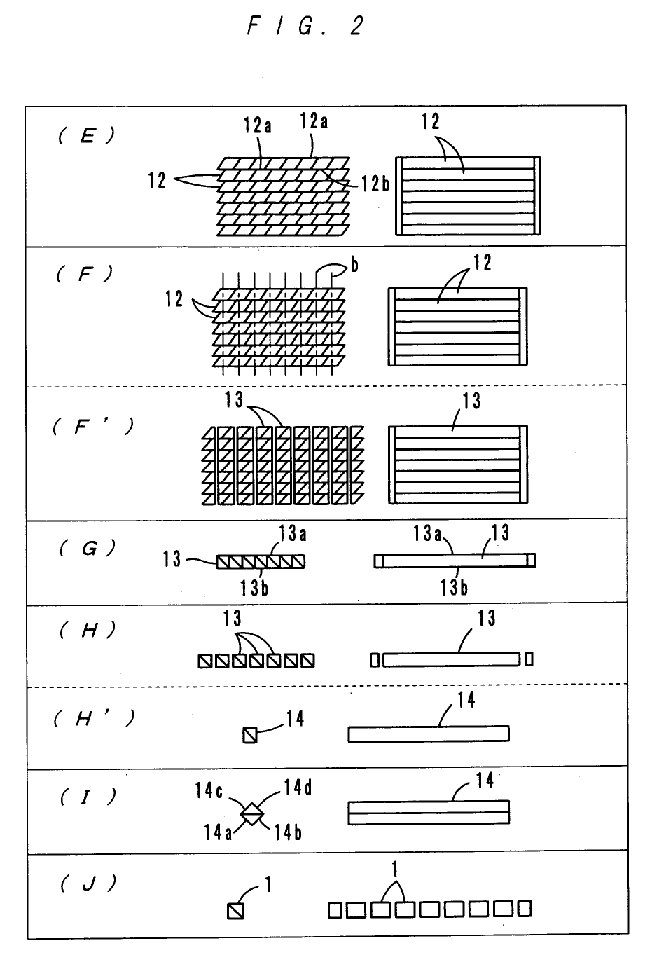

### First Embodiment; See FIGS. 1 and 2

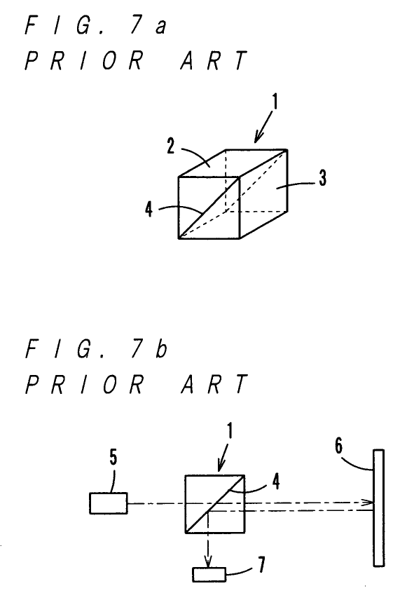

A manufacturing method according to a first embodiment is to manufacture beam splitters 1 as shown by FIG. 7a. This manufacturing method is carried out following the steps (A) to (J) shown by FIGS. 1 and 2.

First, at step (A), a plural number of glass planar plates 10 are prepared, and a light-separating coating (a polarized-light-separating coating or a wave-separating coating) is formed on one surface of each of the planar plates 10. The light-separating coating is, for example, a PBS coating, a dichroic coating or the like.

At step (B), the planar plates 10 are overlapped to make stairs inclining at a specified angle of θ (for example, 45 degrees), and the overlapped planar plates 10 are bonded together by a first adhesive into a laminate 11. At this step (B), it is effective to use a jig with an inclined surface 21 at an angle of θ.

Preferably, the first adhesive is not soluble in a solvent and is translucent, and an ultraviolet cure adhesive is suited to be used as the first adhesive. Also, the first adhesive preferably has a refractive index nearly equal to that of the glass material of the planar plates 10.

At step (B), the planar plates 10 are not necessarily overlapped at an angle of θ. However, in view of a cutting process at the next step (C), overlapping the planar plates 10 is advantageous because it prevents waste of the material.

Next, at step (C), the laminate 11 is cut in a first cutting direction at the inclination θ at a pitch (see the alternate long and short dash lines “a”). Thus, the laminate 11 is cut into a plural number of laminate divisions 12 (see (C′)).

At step (D), both cut surfaces 12a and 12b of each of the laminate divisions 12 are polished. The polishing is, for example, lapping. The both surfaces 12a and 12b may be polished concurrently or may be polished one by one. However, it is effective and preferred to polish the both surfaces 12a and 12b concurrently.

At step (E), the laminate divisions 12 are stacked such that the polished surfaces 12a and 12b will face one another, and the stacked laminate divisions 12 are temporarily bonded together by a second adhesive. The second adhesive is used only for temporary bonding and will be removed later, and therefore, the second adhesive is not necessarily translucent but must be soluble in a solvent. Specifically, a soluble ultraviolet cure adhesive is temporarily hardened so as to temporarily bond the stacked laminate divisions 12 together.

As the solvent of the ultraviolet cure adhesive, for example, hydrocarbon cleaner is suited. As a remover (solvent) for dissolving the adhesive, a water remover, hot water (for example, 80° C. or hotter) or an organic solvent can be used in accordance with the kind of the adhesive.

Next, at step (F), the temporarily bonded stack of laminate divisions 12 is cut in a second cutting direction (see the alternate long and short dash lines “b”) perpendicular to the surfaces of stack at a pitch such that the light-separating coatings will not be cut. Thus, the stack of laminate divisions 12 is cut into temporarily bonded plates 13 (see (F′)).

At step (G), both cut surfaces 13a and 13b of each of the temporarily bonded plates 13 are polished. The polishing is, for example, lapping.

At step (H), each of the temporarily bonded plates 13 is dipped into a solvent so as to dissolve the second adhesive. Thus, each of the temporarily bonded plates 13 is divided into long chains of beam splitters 14 (see (H′)).

Next, at step (I), each of the chains of beam splitters 14 is coated with an anti-reflection agent. More specifically, on a first surface 14a and a second surface 14b, which are adjacent to each other, of each chain of beam splitters 14, an anti-reflection coating is formed by vapor deposition at one process. Further, on a third surface 14c and a fourth surface 14d, which are adjacent to each other, an anti-reflection coating is formed by vapor deposition at another process.

At step (J), each chain of beam splitters 14 are cut into pieces of a specified size, and thus, individual beam splitters 1 are produced.

By following the steps (A) to (J), desired beam splitters 1 can be obtained. In this manufacturing method, at step (I), vapor deposition for forming an anti-reflection coating on two adjacent surfaces is carried out two times. The number of vapor deposition processes is only a half of that of a conventional manufacturing method.

Also, since the anti-reflection coating step (I) is carried out after the adhesive removing step (H), there is no possibility that a gas may be generated from the second adhesive by heat for vapor deposition. In this embodiment, an ultraviolet cure adhesive is used as the second adhesive. However, if paraffine is used, there is no possibility that the anti-reflection coating will have YAKE (tarnishing) and/or hazing.

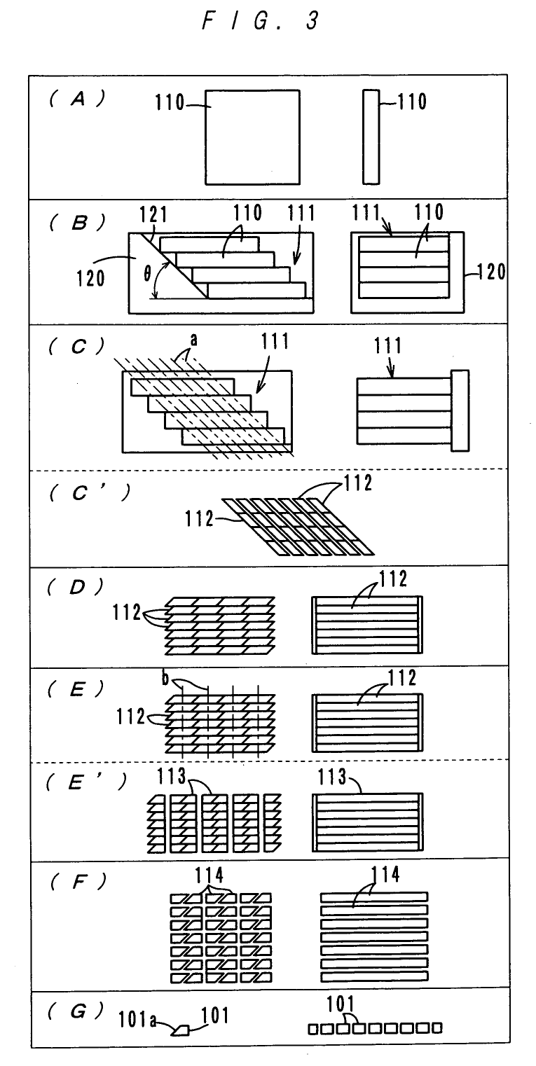

### Second Embodiment; See FIG. 3

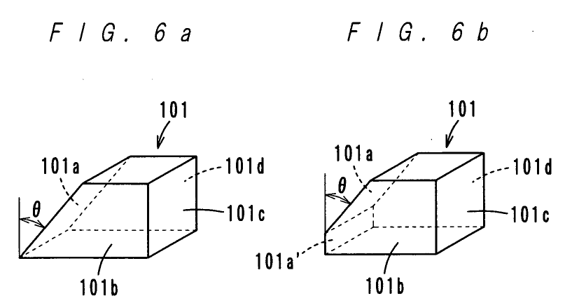

A manufacturing method according to a second embodiment is to manufacture mirrors employed in optical pick-up devices. This manufacturing method is carried out following the steps (A) to (G) shown by FIG. 3. As FIG. 6a shows, each of the mirrors 101 has an inclined surface 101a formed by cutting off a corner of a rectangular parallelopiped and is a prism of a square pole of which vertical sections are trapezoidal. More specifically, each mirror 101 is a prism of a square pole with trapezoidal vertical sections and has three vertical surfaces 101b, 101c and 101d and an inclined surface 101a tilting at an angle of θ.

First, at step (A), a plural number of glass planar plates 110 are prepared, and a reflective coating is formed on both surfaces of each of the planar plates 110. The reflective coating is, for example, a metal coating such as an aluminum coating, a silver coating, etc., a dielectric multi-layered coating or a laminate coating of metal layers and dielectric layers or the like, and these coatings are formed by sputtering.

At step (B), the planar plates 110 are overlapped to make stairs inclining at a specified angle of θ (for example, 45 degrees), and the overlapped planar plates 110 are temporarily bonded together by a first adhesive into a laminate 111. At this step (B), it is effective to use a jig 120 with an inclined surface 121 at an angle of θ. The first adhesive is soluble in a solvent, and for example, a soluble ultraviolet cure adhesive is temporarily hardened to make a laminate 111 of the overlapped plates 110.

As the solvent of the ultraviolet cure adhesive, for example, hydrocarbon cleaner is used. As a remover (solvent) for dissolving the adhesive, a water remover, hot water (for example, 80° C. or hotter) or an organic solvent can be used in accordance with the kind of the adhesive.

At step (B), the planar plates 110 are not necessarily overlapped at an angle of θ. However, in view of a cutting process at the next step (C), overlapping the planar plates 110 is advantageous because it prevents waste of the material.

Next, at step (C), the laminate 111 is cut in a first cutting direction at the inclination θ at a pitch (see the alternate long and short dash lines “a”). Thus, the laminate 111 is cut into a plural number of laminate divisions 112 (see (C′)).

At step (D), the laminate divisions 112 are stacked one upon another such that the respective cut surfaces will face one another, and the stacked laminate divisions 112 are temporarily bonded together by a second adhesive. The second adhesive is soluble in a solvent, and for example, a soluble ultraviolet cure adhesive is temporarily hardened to temporarily bond the stacked laminate divisions 112 together.

Next, at step (E), the temporarily bonded stack of laminate divisions 12 is cut in a second cutting direction (see the alternate long and short dash lines “b”) perpendicular to the surfaces of the stack at a pitch. Thus, the stack of laminate divisions 112 is cut into temporarily bonded plates 113 (see (E′)).

At step (F), each of the temporarily bonded plates 113 is dipped in a solvent so that the first and second adhesives can be removed. Thus, a plural number of long chains of mirrors 114 are formed.

Next, at step (G), each of the chains of mirrors 114 is cut into pieces of a specified size, and thus, individual mirrors 101 are formed.

By following the steps (A) to (G), mirrors 101, each of which has a reflective coating on an inclined surface 101a, can be manufactured. In this manufacturing method, at the step right before obtaining individual mirrors 101, a large number of chains of mirrors, with reflective coatings on the respective inclined surfaces 101a formed, can be effectively obtained.

At step (E), when the stack of laminate divisions 112 is cut in the second direction perpendicular to the surfaces of the stack to make a plural number of temporarily bonded plates 113, the cutting is carried out such that the cut positions will be in the middles of adjacent temporarily bonded surfaces (with reflective coatings thereon) of the plates 110. Thereby, mirrors of identical shapes 101 can be formed efficiently.

Also, when a plural number of laminate divisions 112 are formed at step (C), both cut surfaces of each of the laminate divisions 112 may be polished, and further, when a plural number of temporarily bonded plates 113 are formed at step (E), both cut surfaces of each of the plates 113 may be polished. By performing such polishing, each of the obtained mirrors 101 will have a reflective coating which can be used as an internal reflective coating.

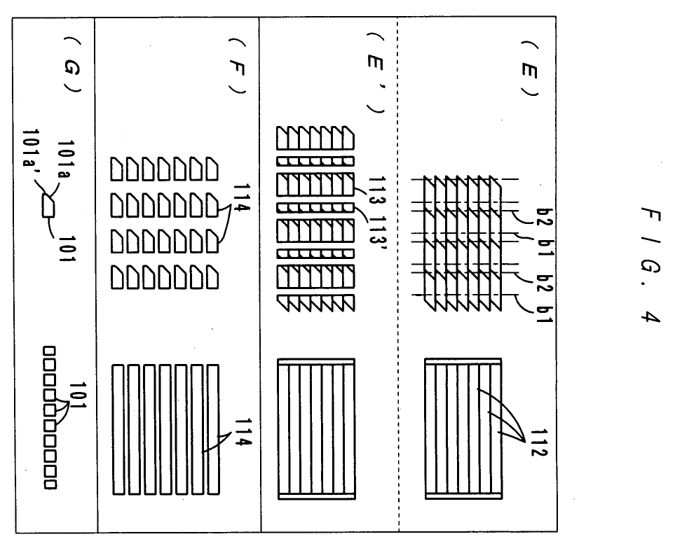

### Third Embodiment; See FIG. 4

A manufacturing method according to a third embodiment comprises steps (A) to (D) as described in connection with the second embodiment. However, on one surface of each of the planar plates 110, a reflective coating is formed. Then, at step (E), as shown in FIG. 4, a stack of laminate divisions 112 is cut along lines b1 and b2 into temporarily bonded plates 113 and 113′ (see Fig. E′). The cutting lines b1 are to make cut surfaces not including the temporarily bonded surfaces (reflective coatings) of the planar plates 110, and the cutting lines b2 are to make cut surfaces including the temporarily bonded surfaces (reflective coatings) of the planar plates 110. The cutting lines b1 and b2 are positioned at a specified pitch, respectively. The following steps (F) and (G) are carried out in the same way as described in connection with the second embodiment. The temporarily bonded plates 113′ are wasted finally.

In the method according to the third embodiment, prismatic mirrors 101, each of which has an inclined surface 101a and a cut-off corner 101a′, can be efficiently manufactured. Each of the mirrors 101, as shown in FIG. 6b, has an inclined surface 101 made by cutting off a corner of a rectangular parallelopiped and is a prism with hexagonal sections. More specifically, each of the mirrors 101 is a hexagonal prism with four surfaces 101b, 101c, 101d and 101a′ orthogonal to one another and a θ-degree inclined surface 101a.

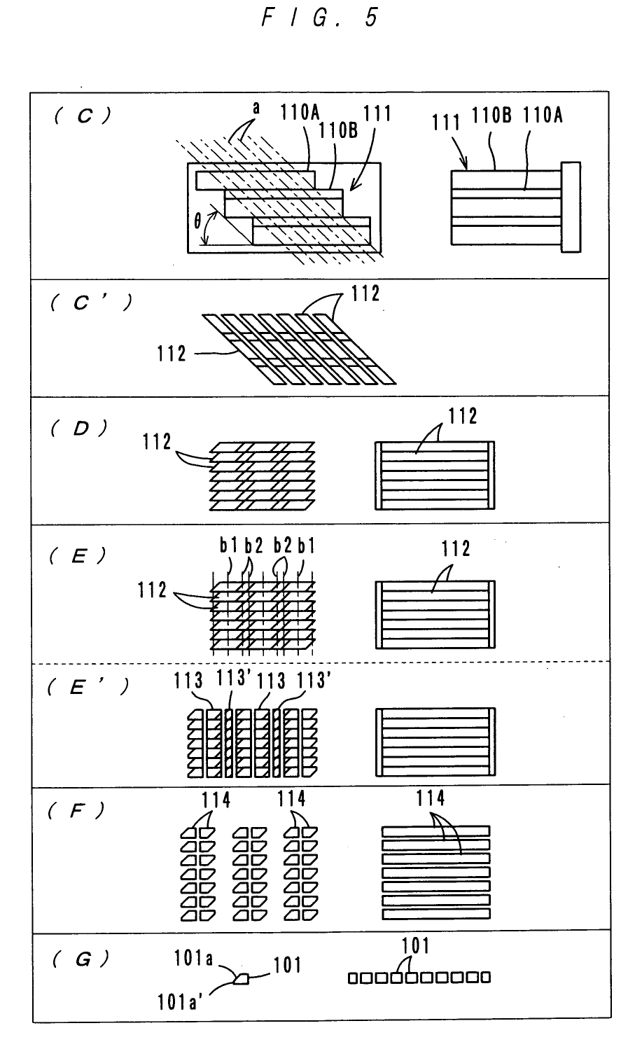

### Fourth Embodiment; See FIG. 5

A method according to a fourth embodiment is to manufacture a large number of mirrors 101, each having a cut-off corner 101a′, efficiently with less waste of material.

Although not shown in FIG. 5, first, at step (A), first glass planar plates which are relatively thick and second glass planar plates which are relatively thin are prepared, and on both surfaces of each of the first planar plates, reflective coatings are formed. Next, at step (B), the first planar plates and the second planar plates are overlapped to make stairs inclining at an angle of θ (for example, 45 degrees), and the overlapped plates are temporarily bonded together by a first adhesive soluble in a solvent. Thus, a laminate of planar plates 111 is made.

Thereafter, at step (C), as shown in FIG. 5, the laminate 111 is cut in a first direction at the inclination θ at a specified pitch (see the alternate long and short dash lines “a”), so that a plural number of laminate divisions 112 (see step (C′)) are made. In step (C) of FIG. 5, “110A” denotes a first glass planar plate, and “110B” denotes a second glass planar plate.

At step (D), the laminate divisions 112 are stacked such that the cut surfaces of the respective laminate divisions 112 will face each other, and the stacked laminate divisions 112 are temporarily bonded together by a second adhesive as described in connection with the second embodiment.

Next, at step (E), the temporarily bonded stack of laminate divisions 112 is cut in a second cutting direction shown by alternate long and short dash lines “b1” and “b2” perpendicular to the surface of the stack, so that a plural number of temporarily bonded plates 113 and a plural number of temporarily bonded plates 113′ (see step (E′)) are made. The cutting lines b1 are at a specified pitch and are to make cut surfaces not including the temporarily bonded surfaces (reflective coatings) between the first planar plates 110A and the second planar plates 110B, that is, are positioned in the middles among the respective temporarily bonded surfaces. The cutting lines b2 are at a specified pitch and are to make cut surfaces including the temporarily bonded surfaces (reflective coatings) between the first planar plates 110A and the second planar plates 110B. By the cutting lines b1, the stack of laminate divisions 112 is cut at the middles of the reflective coatings, and by the cutting lines b2, the ends (corners) 101a′ of the inclined surfaces 101a with reflective coatings thereon are cut off (see step (G)).

At step (F), the temporarily bonded plates 113 are dipped in a solvent, so that the first and second adhesives are removed. Thus, long chains of mirrors 114 are made.

Next, at step (G), each chain of mirrors 114 is cut into pieces of a specified size, and consequently, individual mirrors 101 are obtained.

In the method according to the fourth embodiment, prismatic mirrors 101, each having an inclined surface 101a with a reflective coating thereon and a cut-off corner 101a′, can be manufactured efficiently. Moreover, compared with the method according to the second embodiment, the method according to the fourth embodiment generates less waste of material.

Further, as the method according to the second embodiment, the method according to the fourth embodiment may comprise a step of polishing the both surfaces of each of the laminate divisions 112 after step (C) and a step of polishing the both surfaces of each of the temporarily bonded plates 113 after step (E).

### OTHER EMBODIMENTS

As the adhesives, not only ultraviolet cure adhesives but also visible light cure adhesives and thermosetting adhesives can be used.

The methods according to the second, third and fourth embodiments are to manufacture optical elements with reflective coatings by laminating and processing planar plates with reflective coatings thereon. However, planar plates without reflective coatings thereon may be laminated and processed, and thereafter, reflective coatings may be formed on the respective inclined surfaces of long chains of optical elements or on the respective inclined surfaces of individual optical elements.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A method for manufacturing optical elements, said method comprising the steps of:
preparing a plural number of planar plates made of a transparent material, each of the planar plates having a light-separating coating on one surface;
laminating the planar plates and boding the planar plates together by a translucent first adhesive so as to make a laminate;
cutting the laminate in a first direction inclining at a specified angle at a specified pitch so as to make a plural number of laminate divisions;
polishing both cut surfaces of each of the laminate divisions;
stacking the laminate divisions such that the polished surfaces face each other and temporarily bonding the stacked laminate divisions together by a second adhesive;
cutting the temporarily bonded stack of laminate divisions in a second direction perpendicular to surfaces of the stack so as to make a plural number of temporarily bonded plates;
polishing both surfaces of each of the temporarily bonded plates;
removing the second adhesive so as to make a plural number of long chains of optical elements;
forming an anti-reflection coating on each of the chains of optical elements; and
cutting each of the chains of optical elements into pieces of a specified size so as to make individual optical elements.

2. A method according to claim 1, wherein the first adhesive is a light cure adhesive with a refractive index nearly equal to that of the planar plates.

3. A method according to claim 1, wherein in the step of stacking the laminate divisions and temporarily bonding the stacked laminate divisions together, a light cure adhesive is used as the second adhesive, and the light cure adhesive is temporarily hardened.

4. A method according to claim 1, wherein in the step of forming an anti-reflective coating, adjacent two surfaces of each of the chains of optical elements are concurrently subjected to formation of an anti-reflection coating.

5. A method for manufacturing optical elements, said method comprising:
preparing a plural number of planar plates made of a transparent material;
laminating the planar plates and temporarily boding the planar plates together by a first adhesive so as to make a laminate;
cutting the laminate in a first direction inclining at a specified angle at a specified pitch so as to make a plural number of laminate divisions;
stacking the laminate divisions such that cut surfaces face each other and temporarily bonding the stacked laminate divisions together by a second adhesive;
cutting the temporarily bonded stack of laminate divisions in a second direction perpendicular to surfaces of the stack so as to make a plural number of temporarily bonded plates;
removing the first and second adhesives so as to make a plural number of long chains of optical elements; and
cutting each of the chains of optical elements into pieces of a specified size so as to make individual optical elements.

6. A method according to claim 5, wherein in the step of cutting the temporarily bonded stack of laminate divisions in the second direction, the cutting positions are so designed to make cut surfaces not including the temporarily bonded surfaces of the stack of laminate divisions.

7. A method according to claim 6, wherein in the step of cutting the temporarily bonded stack of laminate divisions in the second direction, the cutting positions are in the middles of the temporarily bonded surfaces of the stack of laminate divisions.

8. A method according to claim 5, wherein in the step of cutting the temporarily bonded stack of laminate divisions in the second direction, the cutting positions are so designed to make cut surfaces including the temporarily bonded surfaces of the stack of laminate divisions.

9. A method according to claim 8, wherein each of the planar plates has a reflective coating on one surface.

10. A method according to claim 5, wherein each of the planar plates has reflective coatings on both surfaces.

11. A method according to claim 5, further comprising a step of forming a reflective coating on an inclined surface of each of the long chains of optical elements or on an inclined surface of each of the optical elements cut out from each of the long chains of optical elements.

12. A method according to claim 5, wherein a light cure adhesive is used as the first and second adhesives and wherein the light cure adhesive is temporarily hardened so as to temporarily bond the planar plates together and so as to temporarily bond the stacked laminate divisions together.

13. A method according to claim 5, further comprising the steps of:
after the step of cutting the laminate into a plural number of laminate divisions, the step of polishing both cut surfaces of each of the laminate divisions; and
after the step of cutting the temporarily bonded stack of laminate divisions into a plural number of temporarily bonded plates, the step of polishing both cut surfaces of each of the temporarily bonded plates.

14. A method for manufacturing optical elements, said method comprising the steps of:
preparing a plural number of first transparent planar plates with a first thickness and a plural number of second planar plates with a second thickness smaller than the first thickness;
laminating the first planar plates and the second planar plates and temporarily boding the first and second planar plates together by a first adhesive so as to make a laminate;
cutting the laminate in a first direction inclining at a specified angle at a specified pitch so as to make a plural number of laminate divisions;
stacking the laminate divisions such that cut surfaces face each other and temporarily bonding the stacked laminate divisions together by a second adhesive;
cutting the temporarily bonded stack of laminate divisions in a second direction perpendicular to surfaces of the stack so as to make a plural number of temporarily bonded plates;
removing the first and second adhesives so as to make a plural number of long chains of optical elements; and
cutting each of the chains of optical elements into pieces of a specified size so as to make individual optical elements,
wherein in the step of cutting the temporarily bonded stack of laminate divisions in the second direction, the cutting positions are so designed to make cut surfaces including the temporarily bonded surfaces of the planar plates and cut surfaces not including the temporarily bonded surfaces of the planar plates.

15. A method according to claim 14, wherein each of the first and second planar plates has reflective coatings on both surfaces.

16. A method according to claim 14, further comprising the step of forming a reflective coating on an inclined surface each of the long chains of optical elements or on an inclined surface of each of the optical elements cut out from the long chains of optical elements.

17. A method according to claim 14, wherein a light cure adhesive is used as the first and second adhesives and wherein the light cure adhesive is temporarily hardened so as to temporarily bond the planar plates together and so as to temporarily bond the stacked laminate divisions together.

18. A method according to claim 14, further comprising the steps of:
after the step of cutting the laminate into a plural number of laminate divisions, the step of polishing both cut surfaces of each of the laminate divisions; and
after the step of cutting the temporarily bonded stack of laminate divisions into a plural number of temporarily bonded plates, the step of polishing both cut surfaces of each of the temporarily bonded plates.
